(19) United States
(12) Patent Application Publication
(10) Pub. No.: US 2024/0299867 A1
(43) Pub. Date: Sep. 12, 2024

(54) FILTER ELEMENT

(71) Applicant: ZUXING CHEN, Yiwu (CN)

(72) Inventor: ZUXING CHEN, Yiwu (CN)

(21) Appl. No.: 18/178,615

(22) Filed: Mar. 6, 2023

(51) Int. Cl. B01D 29/21; B01D 35/30

(52) U.S. Cl. CPC B01D 29/21; B01D 35/30; B01D 2201/0415; B01D 2201/0453

(57) ABSTRACT

A filter element, comprising two sets of cover plates, and the cover plates are provided with water inlets; a plurality of first through holes and second through holes are respectively distributed on outside of a first fixing sleeve and a second fixing sleeve, the first fixing sleeve and the second fixing sleeve are detachably connected between the cover plates, the first fixing sleeve is composed of a plurality of first fixing sleeve components, and the first fixing sleeve components are detachably connected, an accommodating cavity is formed between the first and second fixing sleeve; folded filter paper is arranged inside the accommodating cavity. In this technical solution, the first fixing sleeve, the second fixing sleeve and the cover plates are detachable structures, which can reduce the transportation volume and save transportation and storage costs; users can easily replace the filter element, and the use cost is low.

### TECHNICAL FIELD

The present application relates to the technical field of filter elements, and specifically discloses a filter element.

### BACKGROUND

At present, there are many types of filter elements in the market, and the sizes are different, especially for the filter elements used in the water industry. At this stage, the filter elements used in drinking fountains and swimming pools have the following defects:

1. The existing filter element includes upper and lower end caps, folded filter paper, and a fixing sleeve arranged in the folded filter paper, and the existing filter element is a non-detachable structure with large volume and its storage and transportation costs are high;

2. The existing filter element has an integrated structure. After any part is damaged, it can only be discarded, which causes waste and high use cost.

### SUMMARY

In order to solve the above technical problems, the technical solution proposed by the present application is as follows:

The present application provides a filter element, comprising:

two sets of cover plates, wherein the cover plates are provided with water inlets;

a first fixing sleeve and a second fixing sleeve, wherein a plurality of first through holes and second through holes are respectively distributed on outside of the first fixing sleeve and the second fixing sleeve, wherein the first fixing sleeve and the second fixing sleeve are detachably connected between the cover plates, the first fixing sleeve is composed of a plurality of first fixing sleeve components, and the first fixing sleeve components are detachably connected, wherein an accommodating cavity is formed between the first fixing sleeve and the second fixing sleeve;

a folded filter paper, arranged inside the accommodating cavity.

Further, buckles are provided between the first fixing sleeve components, and the first fixing sleeve components are fixedly connected by the buckles.

Further, the second fixing sleeve components are detachably connected, and the second fixing sleeve is composed of a plurality of second fixing sleeve components.

Further, the second fixing sleeve components are fixedly connected by any one of threading, buckling and socketing, and the second fixing sleeve components are spliced left and right or up and down to form the second fixing sleeve.

Further, a first fixing sleeve-fixing groove and a second fixing sleeve-fixing groove are arranged on the cover plates, and the first fixing sleeve and the second fixing sleeve are fixed between the cover plates by the first fixing sleeve-fixing groove and the second fixing sleeve-fixing groove.

Further, a fixing groove for the folded filter paper is provided between the first fixing sleeve-fixing groove and the second fixing sleeve-fixing groove.

Further, the second fixing sleeve is connected to the cover plate through clamping or threading.

Further, an inner side of the second fixing sleeve-fixing groove is provided with a first thread, an upper and lower ends of the second fixing sleeve are provided with second threads, and the upper and lower ends of the second fixing sleeve are fixedly connected with the cover plates through the cooperation of the first thread and the second thread.

Further, a plurality of ring-shaped fixing tapes are arranged on the folded filter paper.

The beneficial effect of this application is: the present application provides a filter element, comprising two sets of cover plates, and the cover plates are provided with water inlets; a plurality of first through holes and second through holes are respectively distributed on outside of a first fixing sleeve and a second fixing sleeve, the first fixing sleeve and the second fixing sleeve are detachably connected between the cover plates, the first fixing sleeve is composed of a plurality of first fixing sleeve components, and the first fixing sleeve components are detachably connected, an accommodating cavity is formed between the first fixing sleeve and the second fixing sleeve; folded filter paper is arranged inside the accommodating cavity. In this technical solution, the first fixing sleeve, the second fixing sleeve and the cover plates are detachable structures, which can reduce the transportation volume and save transportation and storage costs; users can easily replace the filter element, and the use cost is low.

### BRIEF DESCRIPTION OF THE DRAWINGS

FIG. 1 is the explosion view of the filter element of the present application;

FIG. 2 is the perspective view of the filter element of the present application;

FIG. 3 is an enlarged view of A in the perspective view of the filter element in FIG. 2;

FIG. 4 is a schematic structural diagram of a cover plate in the filter element of the present application.

Reference signs: 1—Cover plate, 101—Fixing groove for the folded filter paper, 102—First fixing sleeve-fixing groove, 103—First thread, 104—Second fixing sleeve-fixing groove, 105—Water inlet, 2—First fixing sleeve, 201—First fixing sleeve component, 202—First through hole, 203—Buckle, 3—Second fixing sleeve, 301—Second fixing sleeve component, 302—Second thread, 303—Second through hole, 4—Folded Filter paper, 401—Ring-shaped fixing tape.

### DETAILED DESCRIPTION

In order to enable those skilled in the art to better understand the technical solutions of the present application, the technical solutions in the embodiments of the present application will be clearly and completely described below in conjunction with the drawings in the embodiments of the present application. Apparently, the described embodiments are only some of the embodiments of the present application, rather than all the embodiments. Based on the embodiments in the present application, all other embodiments obtained by those skilled in the art without making creative efforts belong to the protection scope of the present application.

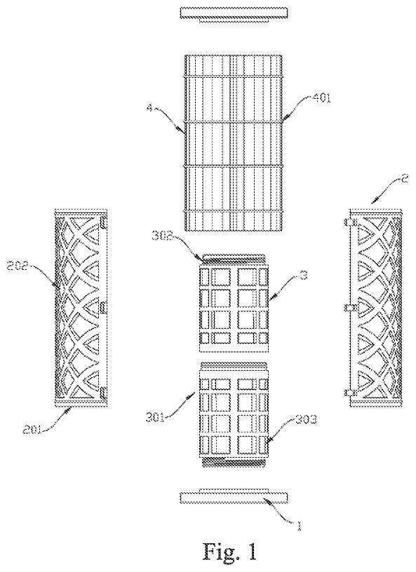

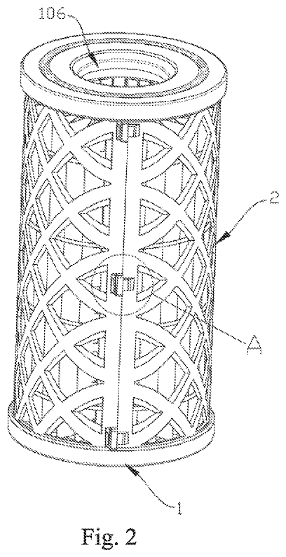

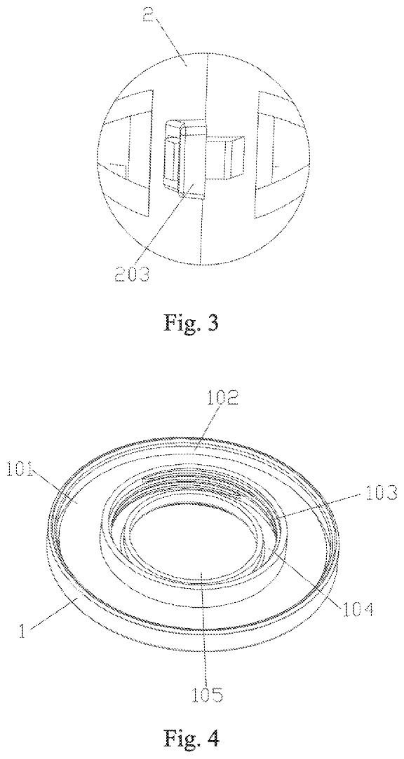

As shown in FIGS. 1-4 1, a filter element comprises two sets of cover plates 1, wherein the cover plates 1 are provided with water inlets 105; a first fixing sleeve 2 and a second fixing sleeve 3, wherein a plurality of first through holes 202 and second through holes 303 are respectively distributed on outside of the first fixing sleeve 2 and the second fixing sleeve 3, wherein the first fixing sleeve 2 and the second fixing sleeve 3 are detachably connected between the cover plates 1, the first fixing sleeve 2 is composed of a plurality of first fixing sleeve components 201, and the first fixing sleeve components 201 are detachably connected, wherein an accommodating cavity is formed between the first fixing sleeve 2 and the second fixing sleeve 3; a folded filter paper 4, arranged inside the accommodating cavity. When in use, the water to be purified enters through the water inlet 105 on the cover plate, and filters out impurities through the folded filter paper 4. The first fixing sleeve 2, the second fixing sleeve 3 and the cover plate 1 are detachable structures, which can reduce the transportation volume and save transportation and storage costs; users can easily replace the filter element, and the use cost is low.

As a preferred implementation of this embodiment, buckles 203 are provided between the first fixing sleeve components 201, and the first fixing sleeve components 201 are fixedly connected by the buckles 203. The use of buckles 203 for connection can ensure that the connection between the first fixing sleeve components 201 is firm and not easily deformed.

Specifically, the second fixing sleeve components 301 are detachably connected, and the second fixing sleeve 3 is composed of a plurality of second fixing sleeve components 301, which reduces the volume of the second fixing sleeve 3 and reduces the transportation and storage costs.

Specifically, the second fixing sleeve components 301 are fixedly connected by any one of threading, buckling and socketing, and the second fixing sleeve components 301 are spliced left and right or up and down to form the second fixing sleeve.

As a preferred implementation of this embodiment, a first fixing sleeve-fixing groove 102 and a second fixing sleeve-fixing groove 104 are arranged on the cover plates 1, and the first fixing sleeve 2 and the second fixing sleeve 3 are fixed between the cover plates 1 by the first fixing sleeve-fixing groove 102 and the second fixing sleeve-fixing groove 104, so that the connection between the first fixing sleeve 2 and the second fixing sleeve 3 and the cover plate 1 is more stable, and the displacement of the first fixing sleeve 2 and the second fixing sleeve 3 is prevented.

Specifically, a fixing groove 101 for the folded filter paper is provided between the first fixing sleeve-fixing groove 102 and the second fixing sleeve-fixing groove 104. The fixing groove 101 for the folded filter paper are located at the upper and lower ends of the accommodating cavity, and are used for fixing the folded filter paper 4.

Specifically, the second fixing sleeve 3 is connected to the cover plate 1 through clamping or threading. An inner side of the second fixing sleeve-fixing groove 102 is provided with a first thread 103, an upper and lower ends of the second fixing sleeve 3 are provided with second threads 302, and the upper and lower ends of the second fixing sleeve 3 are fixedly connected with the cover plates 1 through the cooperation of the first thread 103 and the second thread 302. The clamping or threaded connection can ensure a stable connection between the second fixing sleeve 3 and the cover plate 1.

In addition, a plurality of ring-shaped fixing tapes 401 are arranged on the folded filter paper 4, and the ring-shaped fixing tapes 401 can fix the width of the folded filter paper 4, so that the folded filter paper 4 is located in the accommodating cavity more closely, beautiful and practical.

From the above description, it can be seen that the above-mentioned embodiments of the present application have achieved the following technical effects:

The present application provides a filter element, comprising two sets of cover plates, and the cover plates are provided with water inlets; a plurality of first through holes and second through holes are respectively distributed on outside of a first fixing sleeve and a second fixing sleeve, the first fixing sleeve and the second fixing sleeve are detachably connected between the cover plates, the first fixing sleeve is composed of a plurality of first fixing sleeve components, and the first fixing sleeve components are detachably connected, an accommodating cavity is formed between the first fixing sleeve and the second fixing sleeve; folded filter paper is arranged inside the accommodating cavity. In this technical solution, the first fixing sleeve, the second fixing sleeve and the cover plates are detachable structures, which can reduce the transportation volume and save transportation and storage costs; users can easily replace the filter element, and the use cost is low.

It should be noted that the terminology used here is only for describing specific implementations, and is not intended to limit the exemplary implementations according to the present application. As used herein, singular forms are intended to include plural forms unless the context clearly dictates otherwise. In addition, it should also be understood that when the terms “comprising” and/or “comprises” are used in this specification, it indicates the presence of features, steps, operations, means, components and/or their combination.

The relative arrangements of components and steps, numerical expressions and numerical values set forth in these embodiments do not limit the scope of the present application unless specifically stated otherwise. At the same time, it should be understood that, for the convenience of description, the sizes of the various parts shown in the drawings are not drawn according to the actual proportional relationship. Techniques, methods and devices known to those skilled in the art may not be discussed in detail, but where appropriate, such techniques, methods and devices should be considered part of the Authorized Specification. In all examples shown and discussed herein, any specific values should be construed as illustrative only, and not as limiting. Therefore, other examples of the embodiment may have different values. It should be noted that like numerals and letters denote like items in the following figures, therefore, once an item is defined in one figure, it does not require further discussion in subsequent figures.

In the description of the present application, it should be understood that the orientations or positional relationships indicated by orientation words such as “front, back, up, down, left, right”, “horizontal, longitudinal, vertical” and “top, bottom” etc. are usually based on the orientations or positional relationships shown in the accompanying drawings, only is for the convenience of describing this application and to simplify the description. Unless stated to the contrary, these orientation words do not indicate or imply that the device or element referred to must have a specific orientation or be constructed and operated in a specific orientation, and thus should not be construed as limiting the scope of protection of the present application. In addition, the directional words “inside and outside” mean inside and outside with respect to the outline of each component itself.

It will be understood that when an element is referred to as being “on” or “connected to” another element, It may be directly at or directly connected to the other element, or an indirect connection with an intervening element therebetween. In contrast, when an element is referred to as being “directly on” or “directly connected to” another element, there are no intervening elements present.

In addition, it should be noted that in the description of the present application, words such as “first” and “second” are used to define parts and components, only for the convenience of distinguishing corresponding parts. If there is no other statement, the above-mentioned words have no special meaning, so they cannot be interpreted as limiting the protection scope of the present application. In the description of the present application, unless otherwise specified, the meaning of “plurality” refers to two or more.

The above description is the preferred implementation of the present application. It should be pointed out that those skilled in the art can make some improvements and modifications without departing from the principles of the present application, and these improvements and modifications are also regarded as the protection scope of the present application.

What is claimed is:

1. A filter element, comprising:
two sets of cover plates, wherein the cover plates are provided with water inlets;
a first fixing sleeve and a second fixing sleeve, wherein a plurality of first through holes and second through holes are respectively distributed on outside of the first fixing sleeve and the second fixing sleeve, wherein the first fixing sleeve and the second fixing sleeve are detachably connected between the cover plates, the first fixing sleeve is composed of a plurality of first fixing sleeve components, and the first fixing sleeve components are detachably connected, wherein an accommodating cavity is formed between the first fixing sleeve and the second fixing sleeve;
a folded filter paper, arranged inside the accommodating cavity.

2. The filter element according to claim 1, wherein buckles are provided between the first fixing sleeve components, and the first fixing sleeve components are fixedly connected by the buckles.

3. The filter element according to claim 2, wherein the second fixing sleeve components are detachably connected, and the second fixing sleeve is composed of a plurality of second fixing sleeve components.

4. The filter element according to claim 3, wherein the second fixing sleeve components are fixedly connected by any one of threading, buckling and socketing, and the second fixing sleeve components are spliced left and right or up and down to form the second fixing sleeve.

5. The filter element according to claim 4, wherein a first fixing sleeve-fixing groove and a second fixing sleeve-fixing groove are arranged on the cover plates, and the first fixing sleeve and the second fixing sleeve are fixed between the cover plates by the first fixing sleeve-fixing groove and the second fixing sleeve-fixing groove.

6. The filter element according to claim 5, wherein a fixing groove for the folded filter paper is provided between the first fixing sleeve-fixing groove and the second fixing sleeve-fixing groove.

7. The filter element according to claim 6, wherein the second fixing sleeve is connected to the cover plate through clamping or threading.

8. The filter element according to claim 7, wherein an inner side of the second fixing sleeve-fixing groove is provided with a first thread, an upper and lower ends of the second fixing sleeve are provided with second threads, and the upper and lower ends of the second fixing sleeve are fixedly connected with the cover plates through the cooperation of the first thread and the second thread.

9. The filter element according to claim 8, wherein a plurality of ring-shaped fixing tapes are arranged on the folded filter paper.
